(19) United States
(12) Patent Application Publication
(10) Pub. No.: US 2024/0340298 A1
(43) Pub. Date: Oct. 10, 2024

(54) METHOD AND SYSTEM FOR RECOGNIZING TLS FINGERPRINTS BASED ON FINITE-STATE MACHINES

(71) Applicant: Huazhong University of Science and Technology, Wuhan City (CN)

(72) Inventors: Bin YUAN, Wuhan City (CN); Huan LIU, Wuhan City (CN); Jiajun REN, Wuhan City (CN); Qunjinming CHEN, Wuhan City (CN); Deqing ZOU, Wuhan City (CN); Hai JIN, Wuhan City (CN)

(21) Appl. No.: 18/475,471

(22) Filed: Sep. 27, 2023

(30) Foreign Application Priority Data
Apr. 7, 2023 (CN) 202310387803.6

(51) Int. Cl. H04L 9/40

(52) U.S. Cl. CPC H04L 63/1425; H04L 63/166

(57) ABSTRACT

A method and system for recognizing TLS fingerprints based on finite-state machines is provided, wherein the system at least includes: a model inference module, for learning state machine models of target TLS implementations according to mapping information sent by a message mapping module; a fingerprint extracting module, for analyzing the state machine models and extracting multi-level fingerprints of the target TLS implementations; and a version recognizing module, for verifying the multi-level fingerprints for validity and/or recognizing version information of unknown TLS implementations. As compared to other network protocol identification systems, the present disclosure can identify and judge fine-grained information such as the specific implementation type and version of the specific TLS implementation. At the same time, the inventive method is highly automated, thereby ensuring good usability and scalability.

### CROSS-REFERENCE TO RELATED APPLICATION

This application which claims the benefits of priority to Chinese Patent Application No. 202310387803.6, filed Apr. 7, 2023, the contents of which are hereby expressly incorporated by reference into the DETAILED DESCRIPTION OF THE APPLICATION below in their entirety.

### BACKGROUND OF THE APPLICATION

### 1. Technical Field

The present disclosure generally relates to cybersecurity, and more particularly to a method and system for recognizing TLS fingerprints based on finite-state machines.

### 2. Description of Related Art

As increasing attention has been paid to cybersecurity, TLS is now one of the most adopted security protocols across the internet, and forming a critical basis on which cybersecurity systems are constructed. Currently, recognition of network protocols is mainly achieved with technologies based on transport-layer ports, payloads, and statistical features. The method based on transport-layer ports performs protocol recognition according to port allocation rules (i.e., the IANA specification). The method based on payloads involves packet analysis and pattern matching. The method based on statistical features performs protocol recognition with the aid of machine learning and statistical features of network flows. However, all of these methods can only identify the protocol to which the network flow belongs, and cannot provide more fine-grained protocol information.

For example, Chinese Patent Publication No. CN113037746A discloses a method and device for client fingerprint extraction, identity identification and network security detection. The method for client fingerprint extraction comprises the following steps: receiving a webpage access request of a client; determining the TLS fingerprint of the client according to the webpage access request; performing feature extraction on the TLS fingerprint to obtain a feature set of the TLS fingerprint; and performing dimensionality reduction processing on the feature set of the TLS fingerprint based on a simhash algorithm to obtain a target fingerprint for representing the network identity of the client. The disclosed embodiments also provide an electronic device, a computer-readable storage medium, and a computer program product. The prior disclosure is an example of the methods that merely tell in which protocol type a network data packet is, and cannot provide fine-grained protocol information. It is also unable to detect TLS vulnerability.

Therefore, the aim of the present disclosure is to provide fine-grained protocol information by improving the existing art in fingerprint extraction and fingerprint recognition, thereby providing further possibility, e.g., for detection of TLS vulnerability infringement of software copyright.

Since there is certainly discrepancy between the existing art comprehended by the applicant of this patent application and that known by the patent examiners and since there are many details and disclosures disclosed in literatures and patent documents that have been referred by the applicant during creation of the present disclosure not exhaustively recited here, it is to be noted that the present disclosure shall actually include technical features of all of these existing works, and the applicant reserves the right to supplement the application with the related art more existing technical features as support according to relevant regulations.

### SUMMARY OF THE APPLICATION

In view of the shortcoming of the existing art, the present disclosure provides a system for recognizing TLS fingerprints based on finite-state machines, the system at least comprising:
a model inference module, for inferring state machine models of target TLS implementations according to mapping information sent by a message mapping module;
a fingerprint extracting module, for analyzing the state machine models and extracting multi-level fingerprints of the target TLS implementations; and
a version recognizing module, for verifying the multi-level fingerprints for validity and/or recognizing version information of unknown TLS implementations.

The present disclosure solves the problem of existing network protocol recognizing methods about being incapable of providing fine-grained protocol information, specifically by inferring state machine models of TLS implementations and introducing a multi-level fingerprint extracting algorithm on this basis to recognize types and versions of TLS implementations. As compared to the existing technologies, the present disclosure provides protocol information at the finer grain, and reports exact software names and versions on tested TLS servers with higher accuracy. Besides, compared to existing approaches to TLS fingerprint extraction based on data packet loads, the present disclosure sends fewer data packets during fingerprint matching, and is more covert.

Preferably, the model inference module is connected to a state machine model library, and the model inference module verifies, on the basis of equivalence query algorithm in a model testing unit, whether the inferred state machine models represent complete behavior of the target TLS implementations; if so, the inferred state machine models are stored into the state machine model library; and if not, counterexample information is fed back to a model learning unit to direct re-inference of the models until the model passes the test.

Preferably, the model inference module at least comprises the model learning unit and the model testing unit, wherein the model learning unit is for learning the state machine models of the target TLS implementations according to a state machine learning algorithm; and the model testing unit is for determining whether the inferred state machine models represent the complete behavior of the target TLS implementations.

Preferably, the fingerprint extracting module at least comprises: a model analyzing unit, for extracting features of the state machine models and clustering these state machine models; a model comparing unit, for performing analytic comparison among the state machine models of different types, so as to obtain at least one fingerprints that is in a first range; and a fingerprint extracting unit, for identifying intersections of comparison results between the state machines of individual types and the stored state machines, so as to obtain fingerprints in a second range.

Preferably, when some of the state machine models does not have any fingerprints, the fingerprint extracting unit filters out the state machine models for which fingerprints have been found and feeds an instruction for re-comparison back to the model comparing unit; otherwise, the fingerprint extracting unit outputs all of the fingerprints.

Preferably, the fingerprint extracting module comprises a fingerprint updating unit, wherein the fingerprint updating unit updates the fingerprints at least through steps of: calculating the fingerprints of the target TLS implementations; according to a level in which the fingerprints exist, updating all of the fingerprints having existed in this level; comparing the state machine models corresponding to the fingerprints having existed in this level and the state machine models of the target TLS implementations, respectively, so as to obtain comparison results between individual state machine models and the state machines for the target TLS implementations; and identifying intersections between the fingerprints of each of the state machine models and the comparison results, and using the intersections as the updated fingerprints.

When a new TLS state machine model fingerprint is found, the existing multi-level fingerprints can be easily updated by the fingerprint updating unit through incremental updating without the need of recalculating, thereby ensuring scalability of the system.

Preferably, the version recognizing module at least comprises a fingerprint matching unit and a fingerprint verifying unit, wherein the fingerprint matching unit is for recognizing version information of unknown TLS implementations according to the multi-level fingerprints; and the fingerprint verifying unit is for verifying the multi-level fingerprints for validity.

Preferably, the system further comprises a multi-level fingerprint pool. The multi-level fingerprint pool is for maintaining multi-level fingerprint data of known TLS implementations, while sending multi-level fingerprints corresponding to the target TLS implementations to the version recognizing module in response to a fingerprint requesting information sent by the version recognizing module.

The present disclosure further provides a method for recognizing TLS fingerprints based on finite-state machines. The method comprises: learning state machine models of target TLS implementations according to mapping information sent by a message mapping module; analyzing the state machine models and extracting multi-level fingerprints of the target TLS implementations; and verifying the multi-level fingerprints for validity and/or recognizing version information of unknown TLS implementations.

Preferably, the method further comprises: calculating the fingerprints of the target TLS implementations; according to a level in which the fingerprints exist, updating all of the fingerprints having existed in this level; comparing the state machine models corresponding to the fingerprints having existed in this level and the state machine models of the target TLS implementations, respectively, so as to obtain comparison results between individual state machine models and the state machines for the target TLS implementations; and identifying intersections between the fingerprints of each of the state machine models and the comparison results, and using the intersections as the updated fingerprints.

The disclosed TLS fingerprint extracting and version recognizing method based on finite-state machines eliminates the need of manually marking data. The model inference module, the message mapping module, the fingerprint extracting module and the version recognizing module are all highly automated, thereby ensuring usability of the system.

### BRIEF DESCRIPTION OF THE DRAWINGS

FIG. 1 is a structural diagram of a model inference module according to a preferred embodiment of the present disclosure;

FIG. 2 is a flowchart of a fingerprint extracting method implemented by a system for recognizing TLS fingerprints according to a preferred embodiment of the present disclosure; and

FIG. 3 is a schematic drawing showing module connection of a system for recognizing TLS fingerprints according to a preferred embodiment of the present disclosure.

### DETAILED DESCRIPTION OF THE APPLICATION

The present disclosure will be further detailed below with reference to accompanying drawings and particular embodiments.

In view of the shortcomings of the existing art, the present disclosure provides a method and system for recognizing TLS fingerprints based on finite-state machines. The present disclosure further provides a method for learning state machines for TLS implementations.

Some terms used herein have definitions as provided below.

Transport Layer Security (TLS) protocol is designed for providing confidentiality and data integrity between two communication applications over the Internet. TLS handshake refers to a multi-step process for exchanging a series of data packets and messages between a client and a server. Only when the server and the client satisfy the information required by handshake therebetween through the various steps, can further data exchange be performed.

A state machine model library is for storing state machine models learned by a model inference module 200 and providing the fingerprint extracting module 600 with the learned TLS state machine models.

A testing unit is for learning state machines, converting abstract information into concrete information, and sending it to a black-box system under test.

A black-box system is for learning state machines and acting as learning object for a testing unit.

A physical state machine is a state machine physically set inside a black-box system 12, for controlling the behavioral logic of the black-box system 12.

A hypothesis state machine refers to an interim state machine output in the process where the model learning unit 201 executes the state machine learning algorithm. If the interim state machine passes the conformance test conducted by the model testing unit 202, it is determined as the final output of the model inference module 200. Otherwise, the model testing unit 202 provides the model learning unit 201 with a counterexample information, for further optimizing the interim state machine. The aforementioned steps shall be repeated until the interim state machine passes the conformance test conducted by the model testing unit.

A finite-state machine model is suitable for describing state-transition properties of network protocols, and considered as the most adopted formal description format. A finite-state machine model is usually represented by a digraph, wherein vertices denote states and directed edges denote state transitions. The directed edges are marked with inputs and outputs as transition conditions.

An equivalence query is made to verify whether a hypothesis state machine 14 and a physical state machine 13 are identical.

A member query is made in order to construct a hypothesis state machine 14 by providing an abstract request sequence and observing an abstract response sequence.

An abstract request sequence is essentially a symbolized result of a protocol message. For example, ClientHello represents a TLS data packet in a network flow having a type field of ClientHello. Testing tools are used for mutual conversion between abstract characters and concrete protocol messages.

Existing methods for recognizing TLS fingerprints are generally based on analysis of data packet loads of protocols and tend to produce undesirably coarse-grained results with matched fingerprints. Deep-learning-based extraction of flow fingerprint features from the existing art requires collection of massive real-world data packets, and means huge working loads for data marking and data training. Moreover, the known approaches that use a single feature library for extraction of fingerprints tend to generate lengthy and jumbled fingerprints.

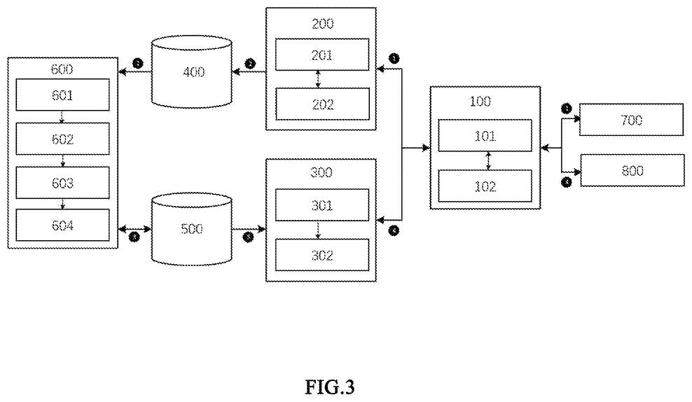

As shown in FIG. 3, the disclosed system for recognizing TLS fingerprints based on finite-state machines at least comprises a model inference module 200, a fingerprint extracting module 600, and a version recognizing module 300. The model inference module 200 is provided with a first information transport port configured to be connected to a message mapping module 100 in a wired or wireless manner. The model inference module 200 is provided with a second information transport port configured to be connected to a state machine model library 400 in a wired or wireless manner.

The version recognizing module 300 is provided with a third information transport port configured to be connected to the message mapping module 100 in a wired or wireless manner. The version recognizing module 300 is provided with a fourth information transport port configured to be connected to a multi-level fingerprint pool 500 in a wired or wireless manner.

A fingerprint extracting module 600 is provided with at least one fifth information transport port configured to be connected to the state machine model library 400 and the multi-level fingerprint pool 500.

The state machine model library 400 and the multi-level fingerprint pool 500 are off-line constructed in advance. It is desired that, prior to fingerprint recognition, state machine models for TLS implementations are learnt in advance as many as possible, so as to construct a multi-level fingerprint pool. Quality of the state machine model library 400 and the multi-level fingerprint pool 500 has direct impact on performance of resulting fingerprint recognition.

As shown in FIG. 3, the message mapping module 100 is connected to the model inference module 200 and the version recognizing module 300, respectively, in a wired or wireless manner. The model inference module 200 and the state machine model library 400 are connected in a wired or wireless manner. The version recognizing module 300 and the multi-level fingerprint pool 500 are connected in a wired or wireless manner. The state machine model library 400 and the multi-level fingerprint pool 500 are connected to the fingerprint extracting module 600, respectively.

Preferably, the message mapping module 100 is further configured to be connected to a known TLS implementation module 700 and an unknown TLS implementation module 800, respectively, in a wired or wireless manner.

The known TLS implementation module 700 is a module with a virtual TLS environment built in advance. Through interaction with the model inference module 200, the known TLS implementation module 700 is useful for pre-constructing or expanding/updating the state machine model library 400 and the multi-level fingerprint pool 500. For example, the TLS implementation module 700 may be a server, a processor and/or an ASIC of any version that stores therein a common TLS library, such as OpenSSL, GnuTLS, JSSE, miTLS, mbedTLS, or nss.

The unknown TLS implementation module 800 is usually a TLS software library module deployed on a network server in a real-world environment. The unknown TLS implementation module 800, by interacting with the version recognizing module 300, recognizes its exact TLS type and version. Manufacturers usually use common TLS software libraries or develop custom TLS implementations based on open-source software libraries, wherein protocol state machines remain unchanged, so the method of the present disclosure can be useful for recognition of fingerprints.

The model inference module 200, the fingerprint extracting module 600 and the version recognizing module 300 may each be an ASIC or a processor capable of running corresponding programs. The model inference module 200 may be an ASIC or a processor capable of executing the model learning method of the present disclosure. The version recognizing module 300 may be an ASIC or a processor capable of executing the version recognizing method of the present disclosure. The fingerprint extracting module 600 may be an ASIC or a processor capable of executing the fingerprint extracting method of the present disclosure.

Preferably, the model inference module 200, the fingerprint extracting module 600 and the version recognizing module 300 may be integrated as an ASIC or a processor. The ASIC or processor is capable of executing the model learning method, the version recognizing method, and the fingerprint extracting method of the present disclosure.

The present disclosure further comprises at least one storage unit. The storage unit may be a hard disc, a magnetic medium, a chip or a processor that can store data. The storage unit may be configured to comprise the state machine model library 400 that stores state machine models and the multi-level fingerprint pool 500 that stores multi-level fingerprints.

The state machine model library 400 and the multi-level fingerprint pool 500 may be provided in separate storage units, or may be provided in the same storage unit.

The model inference module 200 learns state machine models of target TLS implementations based on the mapping information sent by the message mapping module 100. The model inference module 200 verifies whether the inferred state machine models represent the complete behavior of the target TLS implementations, wherein the verification is based on the equivalence query algorithm in the model testing unit 202. If so, the inferred state machine models are stored into the state machine model library 400. If the verification fails, counterexample information is fed back to a model learning unit 201 to direct re-inference of the models until the verification is successful. Preferably, the model inference module 200 at least comprises the model learning unit 201 and the model testing unit 202. The model learning unit 201 is for learning the state machine models of the target TLS implementations according to a state machine learning algorithm. The model testing unit 202 is for determining whether the inferred state machine models represent the complete behavior of the target TLS implementations.

Therein, the model learning unit 201 observes the I/O behavior of a target TLS implementation to learn its state machine model.

As shown in FIG. 3, the message mapping module 100 at least comprises a message mapping unit 101 and a state tracing unit 102.

The message mapping unit 101 is for mapping abstract character messages or concrete data packets into concrete data packets or abstract character messages according to the current state information. The state tracing unit 102 is for maintaining the state information during interaction with target TLS implementations.

Specifically, the message mapping unit 101 receives abstract character messages from the model learning unit 201, and based on a TLS specification file, uses the state information stored in the state tracing unit 102 to construct a TLS data packet of the corresponding type. Alternatively, the message mapping unit 101 transforms a message data packet fed back by the state tracing unit 102 into an abstract character message. In other words, the message mapping unit 101 performs mutual mapping between concrete data packets and abstract character messages, and deals with abnormal situations happening during state inference. Therein, abnormal situations may include no response due to system crush or network disconnection. The message mapping unit 101 maps such a situation into specific letters.

Further, the state tracing unit 102 maintains state information related to TLS connection, such as session randoms, key materials, encryption states, etc., and processes abnormal situations, such as no response before timeout, no response due to disconnection, etc.

Specifically, the state tracing unit 102 has two main functions. The first is to provide the message mapping unit 101 with state information of the current protocol flow based on TLS specifications, and help construction of TLS data packets, so as to ensure the values of certain fields in the data packets reflect the state information of a target system. The second is to analyze TLS data packets coming from the target system, and to extract key information of certain fields. The key information may be, for example, a cipher suite, an encryption algorithm, an alert code, etc.

To address the shortcomings of the existing art, the disclosed method and system for recognizing TLS fingerprints based on finite-state machines feature a model inference module 200. The model inference module 200 uses different interaction logics depending on protocol software libraries. By analyzing protocol state machines, it can extract protocol fingerprints, thereby recognizing fine-grained information of the protocol software library. This enables the present disclosure to recognize versions of protocol implementations at servers more accurately than the existing art.

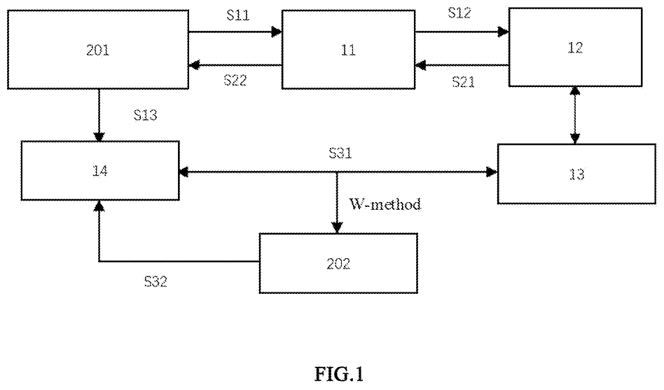

As shown in FIG. 1, the model inference module 200 learns state machines for TLS implementations at least through the following steps.

At the step S11, the model learning unit 201, based on the state machine learning algorithm, interacts with the target protocol implementation through the testing unit 11. The model learning unit 201, based on an active learning algorithm, automatically sends a test request sequence according to predefined input and output alphabets. The request sequence is composed of a series of related abstract character messages.

Existing state machine learning algorithms can be divided into two types, namely active learning and passive learning. Active learning acquires information required for constructing state machines by actively sending a request to a to-be-tested program. Passive learning uses an available data set to construct state machines. As compared to passive learning, active learning provides more complete behavior models for to-be-tested programs. Common active learning algorithms include L* algorithm and the TTT algorithm.

Therein, the state machine learning technology adopted by the model learning unit 201 is realized through an active learning algorithm based on an open-source model learning framework. The active learning algorithm defines two types of queries for collection of information related to target protocol implementations, namely member queries and equivalence queries. The state machine learning algorithm has to capture deep state information of target TLS implementations. The deep state information may be recognized by observing I/O of the target protocol implementation and conducting white-box or grey-box analysis.

Preferably, the model learning unit 201 generates a test request sequence according to the protocol state machine learning algorithm, or collects network flow traces of a target TLS implementation. Where the active learning algorithm is adopted, the model learning unit 201 automatically sends the test request sequence according to predefined input and output alphabets, so as to perform inference of state machines.

Where a passive learning algorithm is adopted, the model learning unit 201 learns state machines according to pre-collected network data packet traces, and determines whether the inferred state machine models represent the complete behavior of the target TLS implementations. If so, it outputs the state machine models, extracts features of the state machine models, and clusters the features. Otherwise, it regenerates a test request sequences for a new iteration to correct the state machine models.

The model learning unit 201 constructs such input sequences using symbols recorded in an input alphabet predefined on the basis of a black-box system 12, and executes the input sequences on system under test (SUT). Meanwhile, outputs of the black-box system 12 are captured and used to update the observation table of the active learning algorithm, thereby making member queries. After each member query, it is necessary to check whether the observation table is consistent and closed. if not, a new input sequence is constructed for a further member query. If so, a hypothesis state machine 14 is generated and an equivalence query is made.

Implementation of equivalence queries depends on the conformance test algorithm in the model testing unit 202, such as W-Method. If the hypothesis state machine 14 passes the conformance test conducted by the model testing unit 202, this is the final output of the model inference module 200. Otherwise, the model testing unit 202 provides the model learning unit 201 with a counterexample information, for further optimizing the hypothesis state machine 14. The foregoing step is repeated until the hypothesis state machine 14 passes the conformance test conducted by the model testing unit 202.

Member queries form the core of the learning algorithm for state machines. Common state machine learning algorithms include the Angluin L*algorithm and the TTT algorithm.

As compared to the existing technology, the model inference module of the present disclosure has valuable advantage. Given that protocol software libraries usually have different interaction logics, the model inference module extracts protocol fingerprints by analyzing protocol state machines, so is able to provide fine-grained information about protocol software libraries, thereby recognizing protocol implementation versions at server-side more accurately.

At the step S12, in response to test request sequence information sent by the model learning unit 201, the testing unit 11 sends concrete request sequence information to the black-box system 12. The testing unit 11 automatically maps the concrete request sequence information into an abstract request sequence. The abstract request sequence represents a test request sequence generated using the active learning algorithm. The concrete request sequence requires conformity in terms of structure of data packets and value of fields.

At the step S21, the black-box system 12 sends the concrete request sequence information to the physical state machine 14. The physical state machine 14 performs state transition based on the sequence information, and feeds back with an output information sequence. Therein, the black-box system 12 receives the output information sequence and constructs a concrete response sequence, which is sent back to the testing unit 11. The output information sequence is essentially the response of the target protocol implementation to a certain message sequence.

At the step S22, the testing unit 11 sends an automatically mapped concrete response sequence to the model learning unit 201 so as to perform abstract response for the model learning unit 201 to learn behavior models of target TLS implementations. The automatic mapping of the abstract message sequence and the concrete data packet sequence requires stateful interaction with the target TLS implementations. Automatic mapping of the abstract message sequence is achieved through operations including tracing cryptographic materials and randoms, generating keys, performing encryption, and dealing with abnormal situations.

Therein, automatic mapping of abstract messages and concrete messages is accomplished using a test tool. The test tool is designed and implemented on the basis of an open-source key protocol software library, and can map concrete network data packets into abstract alphabets that can be processed by the system, thereby separating the model learning algorithm and the encryption/decryption algorithm. This effectively solves problems about limited system performance and low test coverage caused by complexity of the cryptographic algorithm and statefulness of the cryptographic protocol.

Mapping is required to be bijective, which means every possible concrete message has one and only one abstract message corresponding thereto.

It is to be noted that by abstracting common TLS messages, poor efficiency caused by sending massive invalid messages during inference of state machines can be effectively improved. The abstract input and output alphabets for common TLS messages are shown in Table 1.

TABLE 1
Abstract input and output alphabets for common TLS messages

| Input Alphabet | Output Alphabet | Additional Alphabet |
|---|---|---|
| ClientHello (RSA and | ServerHello (RSA and | Empty |
| DHE) | DHE) | |
| Certificate (RSA and | Certificate (RSA and | Connection_Closed |
| empty) | empty) | |
| ClientKeyExchange | CertificateRequest | Decryption_Failed |
| ClientCertificateVerify | ServerKeyExchange | HeartbeatRequest |
| ChangeCipherSpec | ServerHelloDone | HeartbeatResponse |
| Finished | ChangeCipherSpec | Alert (extension) |
| Alert_Close_Notify | Finished | Others |

At the step S31, the model testing unit 202 stops making member queries, and combines results of multiple member queries to update the observation table of the active learning algorithm, thereby generating the hypothesis state machine 14.

The model testing unit 202 determines it is time to stop making more member queries and generate the hypothesis state machine 14 when the following two requirements are met. The first is that the current updated observation table satisfies the requirement of integrity, which means that every inferred state from the observation table is exclusively determinant. The second is that the current updated observation table satisfies the requirement of closure, which means that there will not be new unknown state appearing in the current observation table.

At the step S32, the model testing unit 202 uses the equivalence query algorithm to determine whether the inferred hypothesis state machine 14 is competent to represent the complete behavior of the target black-box system 12.

Equivalence queries use the proximate equivalence query algorithm to verify consistency. The underlying principle is that a limited number of test queries is sued to compare implementations of the inferred hypothesis state machine 14 and the physical state machine 13, and in the event of difference, a counterexample is output to describe the difference therebetween. The counterexample is used to update the observation table and further optimize the hypothesis state machine 14. Otherwise, it is determined that the inferred hypothesis state machine 14 is sufficient to represent behavior features of the black-box system 12.

The fingerprint extracting module 600 is for analyzing state machine models and extracting multi-level fingerprints of target TLS implementations. Preferably, the fingerprint extracting module 600 at least comprises a model analyzing unit 601 for extracting features of the state machine models and clustering the features; a model comparing unit 602 for performing analytic comparison among the state machine models of different types, so as to obtain at least one fingerprints that is in a first range, namely first-range fingerprints; and a fingerprint extracting unit 603 for calculating intersection of pairwise comparison results between state machines of every type and the stored state machines, so as to obtain fingerprints in a second range, namely second-range fingerprints. Preferably, the model comparing unit 602 is for pairwise comparing and analyzing state machine model of different types.

The first-range fingerprints are paths exclusive to the first state machine A in contrast with the second state machine B, i.e., a path set that only exists in the first state machine A and does not exist in the second state machine B.

The second-range fingerprint are paths exclusive to the first state machine A in contrast with all the other known state machines, i.e., a path set that only exists in the first state machine A and does not exist in any other state machines in the state machine model library 400.

The model comparing unit 602 is for pairwise comparing and analyzing state machine models so as to obtain first-range fingerprints. Such a comparison includes two objects, namely the first state machine A and the second state machine B. By means of traversal comparison between the first state machine A and the second state machine B, path information only included in the first state machine A but not included in the second state machine B can be identified. The set of these path information is referred to as the first-range fingerprint of the first state machine A with respect to the second state machine B. The so obtained first-range fingerprint set of the first state machine A opposite to all the other tested state machines will be referred to as the first-range fingerprint set of the first state machine A.

The fingerprint extracting unit 603 is for calculating overlap of first-range fingerprint sets of the state machines so as to obtain the fingerprints in the second range. Taking the first-range fingerprint set of the first state machine A for example, the part shared by all the individuals in the set is the path information set only included by the first state machine A and not included by any other state machine. The shared part is herein referred to as the second-range fingerprint of the first state machine A.

Pairwise comparison and analysis are performed on the state machine models to comparatively analyze path information, node attributes, and edge attributes.

Extracting the features of the state machine model is achieved by:
analyzing a state machine as a special graphic structure, so as to get the number of nodes and the number of edges as well as node attributes and edge attributes; identifying the start node and the end node according to the graphic structure information of the state machine, or manually designating the start node and the end node; according to the start node and the end node, using a graphic transversal algorithm to calculating path information of the state machines; and performing clustering by typifying the same state machine models into the same type.

Preferably, when there is at least one type of state machine models without fingerprints, the fingerprint extracting unit 603 filters out the state machine models for which fingerprints have been found and feeds a re-comparison instruction to the model comparing unit 602. Otherwise, the fingerprint extracting unit 603 outputs all fingerprints.

For state machines of some types, filtration has to be iterated in order to obtain fingerprints. Fingerprints extracted through iterations are referred to as multi-level fingerprints. Fingerprints extracted without using iterated filtration are referred to as Level 1 fingerprints, and every additional iteration causes increment of one to the ordinal of the fingerprint level.

Preferably, the fingerprint extracting module 600 comprises a fingerprint updating unit 604. The fingerprint updating unit 604 is for performing incremental update on multi-level fingerprints.

The fingerprint updating unit 604 updates the fingerprints at least through steps of: calculating the fingerprints of the target TLS implementations; according to a level in which the fingerprints exist, updating all of the fingerprints having existed in this level; comparing the state machine models corresponding to the fingerprints in this level and the state machine models of the target TLS implementations, respectively, so as to obtain pairwise comparison results between individual state machine models and the state machines for the target TLS implementations; and identifying intersections between the fingerprints of each of the state machine models and the pairwise comparison results, and using the intersections as the updated fingerprints.

When a new TLS state machine model fingerprint is found, the existing multi-level fingerprints can be easily updated by the fingerprint updating unit through incremental updating without the need of recalculating, thereby ensuring scalability of the system.

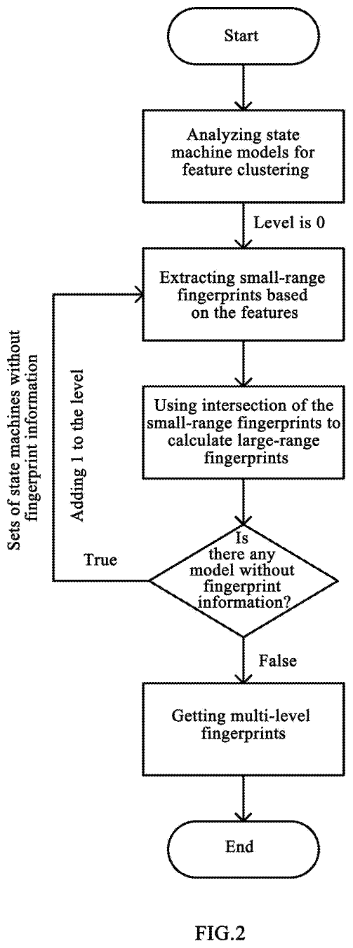

Preferably, as shown in FIG. 2, the present disclosure further provides a multi-level fingerprint extracting method, which comprises the following steps:
S101: analyzing the state machine models for feature clustering, at which time the level is 0;
S102: extracting first-range fingerprints based on the features;
S103: using intersection of the first-range fingerprints to calculate the second-range fingerprints; and
S104: determining whether there is any fingerprint model, and if so, getting multi-level fingerprints; or if not, adding one to the fingerprint level, and returning to the step S102.

The version recognizing module 300 is for verifying the multi-level fingerprints for validity and/or recognizing version information of unknown TLS implementations.

Preferably, the version recognizing module 300 at least comprises a fingerprint matching unit 301 and a fingerprint verifying unit 302. The fingerprint matching unit 301 is for recognizing version information of unknown TLS implementations according to the multi-level fingerprints. The fingerprint verifying unit 302 is for verifying the multi-level fingerprints for validity.

As compared to the existing method that extract fingerprints based on a single feature library, the version recognizing module 300 and the fingerprint extracting module 600 of the present disclosure use an extraction mechanism based on multi-level fingerprints, and perform analytic comparison on clustered fingerprints, so it can recognize an unknown TLS library with fewer data packets, thereby minimizing its impact on the network environment and being more covert.

Preferably, the fingerprint verifying unit verifies whether the multi-level fingerprints can effectively recognize version information thereof by randomly selecting a real-world TLS implementation to simulate. The fingerprint verifying unit randomly selects a TLS implementation of some version, and automatically configures and deploys it as a Docker service. Then fingerprint matching is performed against the multi-level fingerprint pool. At last, the version of the matched fingerprint is compared with the version information of the Docker service. If the two are identical, the fingerprint is determined as valid.

The multi-level fingerprint pool 500 is for maintaining multi-level fingerprint data of known TLS implementations, while sending multi-level fingerprints corresponding to the target TLS implementations to the version recognizing module 300 in response to a fingerprint requesting information sent by the version recognizing module 300.

The present disclosure recognizes the type and the version of a TLS implementation by learning state machine models of the TLS implementation and using the multi-level fingerprint extracting algorithm, opposite to the existing network protocol recognizing method that only providing coarse-grained protocol information.

The present disclosure further provides a method for recognizing TLS fingerprints based on finite-state machines. The method at least comprises: learning state machine models of target TLS implementations according to mapping information sent by the message mapping module 100; analyzing the state machine models and extracting multi-level fingerprints of the target TLS implementations; verifying the multi-level fingerprints for validity and/or recognizing version information of unknown TLS implementations.

Recognition of version information of an unknown TLS implementation is achieved as below.

The process begins with Level 1 fingerprints. A fingerprint request sequence is sent, and then observation is made to determine whether the response sequence of the to-be-tested protocol implementation is identical to the fingerprint response sequence. If so, it is verified that the type version of the to-be-tested protocol implementation is identical to the type version of the state machine to which the fingerprint belongs. Otherwise, verification is performed for the next fingerprint. If no match is found among the Level 1 fingerprints, matching is performed among Level 2 fingerprints and so on, until the version information of the to-be-tested protocol implementation is recognized.

Preferably, the method further comprises: calculating the fingerprints of the target TLS implementations; according to a level in which the fingerprints exist, updating all of the fingerprints having existed in this level; comparing the state machine models corresponding to the fingerprints in this level and the state machine models of the target TLS implementations, so as to obtain pairwise comparison results between individual state machine models and the state machines for the target TLS implementations; and identifying intersections between the fingerprints of each of the state machine models and the pairwise comparison results, and using the intersections as the updated fingerprints.

The disclosed TLS fingerprint extracting and version recognizing method based on finite-state machines eliminates the need of manually marking data. The model inference module, the message mapping module, the fingerprint extracting module and the version recognizing module are all highly automated, thereby ensuring usability of the system and efficiency of fingerprint extraction.

It is clear from the above that in the disclosed multi-level fingerprint method, features of state machines are extracted and clustered for pairwise analysis and comparison so as to find out state machine fingerprints. By filtering out state machine models with found fingerprints and iterating the foregoing steps, fingerprints of state machine models of all types can be identified, thereby accomplishing fine-grained version recognition.

Examples of applications of the present disclosure are described below.

Assuming that an attacker A intends to attack a network server S of some company, if the attacker A adopts the existing protocol fingerprint method, transversal of the fingerprint library has to be conducted and massive detecting data packets have to be sent to recognize the protocol type of the network server S through one-by-one matching, thereby making the attack easy to be discovered and intercepted by the network administrator of the attackee.

In virtue of the multi-level fingerprint pool 500, the disclosed finite-automaton-based TLS fingerprint recognizing system allows an attacker A to know the TLS protocol software library and the exact version of the network server S with merely a few detecting data packets sent, so is more efficient and more covert. Further, by combining a TLS vulnerability library and version information of the network server S, the attacker A can initiate targeted attacks against the network server S.

As the defender, the network server S can use the system of the present disclosure to extract fingerprints of a deployed TLS software library, and then improve security of its system by eliminating the fingerprints of the deployed TLS software library or, with additional use of a firewall, specifically processing data packet sequences corresponding to the fingerprints.

It is to be noted that the particular embodiments described previously are exemplary. People skilled in the art, with inspiration from the disclosure of the present disclosure, would be able to devise various solutions, and all these solutions shall be regarded as a part of the disclosure and protected by the present disclosure. Further, people skilled in the art would appreciate that the descriptions and accompanying drawings provided herein are illustrative and form no limitation to any of the appended claims. The scope of the present disclosure is defined by the appended claims and equivalents thereof. The disclosure provided herein contains various inventive concepts, such of those described in sections led by terms or phrases like “preferably”, “according to one preferred mode” or “optionally”. Each of the inventive concepts represents an independent conception and the applicant reserves the right to file one or more divisional applications therefor.

What is claimed is:

1. A system for recognizing TLS fingerprints based on finite-state machines, the system at least comprising:
a model inference module, for learning state machine models of target TLS implementations according to mapping information sent by a message mapping module;
a fingerprint extracting module, for analyzing the state machine models and extracting multi-level fingerprints of the target TLS implementations; and
a version recognizing module, for verifying the multi-level fingerprints for validity and/or recognizing version information of unknown TLS implementations.

2. The system of claim 1, wherein the model inference module is connected to a state machine model library, and
the model inference module verifies, on the basis of equivalence query algorithm in a model testing unit, whether the inferred state machine models represent complete behavior of the target TLS implementations.

3. The system of claim 1, wherein if the inferred state machine models represent complete behavior of the target TLS implementations, the inferred state machine models are stored into the state machine model library; and if the inferred state machine models do not represent complete behavior of the target TLS implementations, counterexample information is fed back to a model learning unit to direct re-inference of the models until the verification is successful.

4. The system of claim 3, wherein the model inference module at least comprises the model learning unit and the model testing unit, wherein
the model learning unit is for learning the state machine models of the target TLS implementations according to a state machine learning algorithm; and
the model testing unit is for determining whether the inferred state machine models represent the complete behavior of the target TLS implementations.

5. The system of claim 4, wherein the fingerprint extracting module at least comprises:
a model analyzing unit, for extracting features of the state machine models and clustering the features;
a model comparing unit, for performing analytic comparison among the state machine models of different types, so as to obtain at least one fingerprints that is in a first range; and
a fingerprint extracting unit, for identifying intersections of comparison results between the state machines of individual types and the stored state machines, so as to obtain fingerprints in a second range.

6. The system of claim 5, wherein when some of the state machine models does not have any fingerprints, the fingerprint extracting unit filters out the state machine models for which fingerprints have been found and feeds an instruction for re-comparison back to the model comparing unit, or
the fingerprint extracting unit outputs all of the fingerprints.

7. The system of claim 6, wherein the fingerprint extracting module comprises a fingerprint updating unit, which updates the fingerprints at least through steps of:
calculating the fingerprints of the target TLS implementations;
according to a level in which the fingerprints exist, updating all of the fingerprints having existed in this level;
comparing the state machine models corresponding to the fingerprints in this level and the state machine models of the target TLS implementations, respectively, so as to obtain comparison results between individual state machine models and the state machines for the target TLS implementations; and
identifying intersections between the fingerprints of each of the state machine models and the comparison results, and using the intersections as the updated fingerprints.

8. The system of claim 7, wherein the version recognizing module at least comprises a fingerprint matching unit and a fingerprint verifying unit, wherein
the fingerprint matching unit is for recognizing version information of unknown TLS implementations according to the multi-level fingerprints; and
the fingerprint verifying unit is for verifying the multi-level fingerprints for validity.

9. The system of claim 8, further comprising a multi-level fingerprint pool, wherein
the multi-level fingerprint pool is for maintaining multi-level fingerprint data of known TLS implementations, while sending multi-level fingerprints corresponding to the target TLS implementations to the version recognizing module in response to a fingerprint requesting information sent by the version recognizing module.

10. The system of claim 9, wherein the model learning unit constructs input sequences using symbols recorded in an input alphabet predefined on the basis of a black-box system, and executes the input sequences on system under test;
outputs of the black-box system are captured and used to update the observation table of the active learning algorithm, thereby making member queries.

11. A method for recognizing TLS fingerprints based on finite-state machines, the method at least comprising:
learning state machine models of target TLS implementations according to mapping information sent by a message mapping module;
analyzing the state machine models and extracting multi-level fingerprints of the target TLS implementations; and
verifying the multi-level fingerprints for validity and/or recognizing version information of unknown TLS implementations.

12. The method of claim 11, further comprising:
calculating the fingerprints of the target TLS implementations;
according to a level in which the fingerprints exist, updating all of the fingerprints having existed in this level;
comparing the state machine models corresponding to the fingerprints having existed in this level and the state machine models of the target TLS implementations, respectively, so as to obtain pairwise comparison results between individual state machine models and the state machines of the target TLS implementations; and
identifying intersections between the fingerprints of each of the state machine models and the pairwise comparison results, and using the intersections as the updated fingerprints.

13. The method of claim 12, if the inferred state machine models represent complete behavior of the target TLS implementations, the inferred state machine models are stored into the state machine model library; and if the inferred state machine models do not represent complete behavior of the target TLS implementations, counterexample information is fed back to a model learning unit to direct re-inference of the models until the verification is successful.

14. The method of claim 13, wherein the method further comprises:
learning the state machine models of the target TLS implementations according to a state machine learning algorithm; and
determining whether the inferred state machine models represent the complete behavior of the target TLS implementations.

15. The method of claim 14, wherein the method further comprises:
extracting features of the state machine models and clustering the features;
performing analytic comparison among the state machine models of different types, so as to obtain at least one fingerprints that is in a first range;
identifying intersections of comparison results between the state machines of individual types and the stored state machines, so as to obtain fingerprints in a second range.

16. The method of claim 15, the method further comprises:
when some of the state machine models does not have any fingerprints, filtering out the state machine models for which fingerprints have been found and feeding an instruction for re-comparison back to the model comparing unit, or
outputting all of the fingerprints.

17. The method of claim 16, wherein the method further comprises:
updating the fingerprints at least through steps of:
calculating the fingerprints of the target TLS implementations;
according to a level in which the fingerprints exist, updating all of the fingerprints having existed in this level;
comparing the state machine models corresponding to the fingerprints in this level and the state machine models of the target TLS implementations, respectively, so as to obtain comparison results between individual state machine models and the state machines for the target TLS implementations; and
identifying intersections between the fingerprints of each of the state machine models and the comparison results, and using the intersections as the updated fingerprints.

18. The method of claim 17, wherein the method further comprises:
recognizing version information of unknown TLS implementations according to the multi-level fingerprints; and
verifying the multi-level fingerprints for validity.

19. The method of claim 18, wherein the method further comprises:
maintaining multi-level fingerprint data of known TLS implementations, while sending multi-level fingerprints corresponding to the target TLS implementations to the version recognizing module in response to a fingerprint requesting information sent by the version recognizing module.

20. The method of claim 19, wherein the method further comprises:
constructing input sequences using symbols recorded in an input alphabet predefined on the basis of a black-box system, and executing the input sequences on system under test;
capturing outputs of the black-box system and using it to update the observation table of the active learning algorithm, thereby making member queries.
